(19) United States
(12) Patent Application Publication
(10) Pub. No.: US 2023/0098782 A1
(43) Pub. Date: Mar. 30, 2023

(54) DISPLAY METHOD, DISPLAY SYSTEM, AND A NON-TRANSITORY COMPUTER-READABLE STORAGE MEDIUM STORING A PROGRAM

(71) Applicant: SEIKO EPSON CORPORATION, Tokyo (JP)

(72) Inventor: Yasuhiro NAKAMURA, Matsumoto-shi (JP)

(21) Appl. No.: 17/953,388

(22) Filed: Sep. 27, 2022

(30) Foreign Application Priority Data
Sep. 28, 2021 (JP) 2021-157602

(51) Int. Cl. G06K 19/06; G06K 19/067

(52) U.S. Cl. CPC G06K 19/06037; G06K 19/067

(57) ABSTRACT

A display method includes acquiring first information from a marker in which the first information is recorded, displaying an image concerning a first procedure in work corresponding to the first information, acquiring the first information from the marker again after the displaying the image concerning the first procedure, and, after the acquiring the first information again, displaying an image concerning a second procedure performed later than the first procedure in the work, the second procedure corresponding to the first information.

The present application is based on, and claims priority from JP Application Serial Number 2021-157602, filed Sep. 28, 2021, the disclosure of which is hereby incorporated by reference herein in its entirety.

### BACKGROUND

### 1. Technical Field

The present disclosure relates to a display method, a display system, and a non-transitory computer-readable storage medium storing a program.

### 2. Related Art

A technique for supporting an operator by displaying an image concerning a procedure of work such as cooking has been developed. For example, JP-A-2010-191745 discloses a cooking support device that supports cooking of ingredients. The cooking support device disclosed in JP-A-2010-191745 includes an imaging section configured to image an ingredient as an object, a projecting section for projecting an image, an identifying section configured to identify, with image processing based on a captured image, a kind of the ingredient imaged in the image; and a cooking method determining section configured to determine a cooking method for the ingredient according to the identified kind of the ingredient. The projecting section projects an image representing the determined cooking method over the ingredient.

JP-A-2010-191745 does not describe a technical configuration concerning how the projected image is switched from an image concerning a certain procedure in determined cooking work to an image concerning a procedure performed later than the certain procedure. Accordingly, a user of the cooking support device sometimes cannot appropriately switch the projected image to a desired image.

### SUMMARY

According to an aspect of the present disclosure, there is provided a display method including: acquiring first information from a marker in which the first information is recorded; displaying an image concerning a first procedure in work corresponding to the first information; acquiring the first information from the marker again after the displaying the image concerning the first procedure; and, after the acquiring the first information again, displaying an image concerning a second procedure performed later than the first procedure in the work corresponding to the first information.

According to an aspect of the present disclosure, there is provided a display system including a sensor, a display device, and a processing device configured to control the sensor and the display device. The processing device execute: controlling the sensor to thereby acquire first information from a marker in which the first information is recorded; controlling the display device to thereby display an image concerning a first procedure in work corresponding to the first information; controlling the sensor to thereby acquire the first information from the marker again after the displaying' the image concerning the first procedure; and, after the acquiring the first information again, controlling the display device to thereby display an image concerning a second procedure performed later than the first procedure in the work corresponding to the first information.

According to an aspect of the present disclosure, there is provided a non-transitory computer-readable storage medium storing a program, the program instructing a processing device to: acquire first information from a marker in which the first information is recorded; display an image concerning a first procedure in work corresponding to the first information; acquire the first information from the marker again after the displaying the image concerning the first procedure; and, after the acquiring the first information again, display an image concerning a second procedure performed later than the first procedure in the work corresponding to the first information.

### BRIEF DESCRIPTION OF THE DRAWINGS

FIG. is a schematic diagram illustrating an environment of use of a projector according to a first embodiment.

FIG. 2 is a block diagram showing the configuration of the projector according to the first embodiment.

FIG. 3 is a block diagram showing a functional configuration of a controller according to the first embodiment.

FIG. 4 is an explanatory diagram showing an example of a marker according to the first embodiment.

FIG. 5 is an explanatory diagram schematically showing a database provided in an image server.

FIG. 6 is a schematic diagram illustrating a state of image projection of the projector according to the first embodiment.

FIG. 7 is a schematic diagram showing an example of a projection image.

FIG. 8 is a schematic diagram showing an example of the projection image.

FIG. 9 is a schematic diagram of an imaging region on a cooking table and the vicinity of the imaging region in a plan view from a −Z direction to a +Z direction.

FIG. 10 is a schematic diagram of the imaging region on the cooking table and the vicinity of the imaging region in the plan view from the −Z direction to the +Z direction.

FIG. 11 is a schematic diagram of the imaging region on the cooking table and the vicinity of the imaging region in the plan view from the −Z direction to the +Z direction.

FIG. 12 is a flowchart for explaining the operation of the projector according to the first embodiment.

FIG. 13 as a block diagram showing the configuration of a projector according a second embodiment.

FIG. 14 is a block diagram showing a functional configuration of a controller according to the second embodiment.

FIG. 15 is a schematic diagram of the imaging region on the cooking table and the vicinity of the imaging region in the plan view from The −Z direction to the +Z direction.

FIG. 16 is a schematic diagram of the imaging region on the cooking table and the vicinity of the imaging region in the plan view from the −Z direction to the +Z direction.

FIG. 17 is a schematic diagram of the imaging region on the cooking table and the vicinity of the imaging region in the plan view from The −Z direction to the +Z direction.

FIG. 18 is a flowchart for explaining the operation of the projector according to the second embodiment.

FIG. 19 is a block diagram showing the configuration of a projector according to a third embodiment.

FIG. 20 is a block diagram showing a functional configuration of a controller according to the third embodiment.

FIG. 21 is a flowchart for explaining the operation of the projector according to the third embodiment.

FIG. 22 is an explanatory diagram showing an example of a display screen in an operation section of the projector according to the first embodiment.

### DESCRIPTION OF EXEMPLARY EMBODIMENTS

Preferred embodiments of the present disclosure are explained below with reference to the accompanying drawings. In the drawings, dimensions and scales of sections are sometimes different from actual ones. Some portions are schematically shown in order to facilitate understanding. The scope of the present disclosure is not limited to these forms unless there is particularly a description to the effect that the present disclosure is limited in the following explanation. In this specification and the claims, when a numerical value range is represented using “Φ to Ψ” (both of Φ and Ψ are numerical values), the range includes numerical values of an upper limit (Ψ) and a lower limit (Φ). Units of the upper limit (Ψ) and the lower limit (Φ) are the same.

### 1. First Embodiment

In a first embodiment, a display method, a display system, and a program according to the present, disclosure are explained illustrating a projector that projects an image.

### 1.1. Overview of the Projector

An overview of a projector 1 according to the first embodiment is explained below with reference to FIG. 1. The projector 1 according to this embodiment is an example of a display system including an imaging section 11, a projecting section 12, and a controller 16 that controls the imaging section 11 and the projecting section 12. The imaging section 11, the projecting section 12, and the controller 16 are explained below.

FIG. 1 is a schematic diagram illustrating an environment of use of the projector 1 according to the first embodiment. In the first embodiment, it is assumed that the projector 1 is fixed to a wall surface 28 for the purpose of projecting an image concerning a procedure of cooking work in a kitchen 20 illustrated in FIG. 1. The kitchen 20 includes, for example, a cooking stove 22, a sink 24, a cooking table 26, and the wall surface 28. The projector 1 controls the imaging section 11 to image a marker M disposed within a range of an imaging region T set on the cooking table 26. The projector 1 projects, based on identification information N recorded in the marker M and process information 151 generated according to the number of times the identification information N is acquired, the image concerning the procedure of the cooking work onto the wall surface 28. Other than the marker M, an object O such as cooking equipment or an ingredient used in the cooking work is disposed on the cooking table 26. The identification information N and the process information 151 are explained below.

In this embodiment, the imaging region T is set on the cooking table 26. However, the imaging region T may include, for example, at least a part of the cooking stove 22 or the sink 24. The projector 1 may project a guide line for clearly showing a range of the imaging region T onto the cooking table 26. The projector 1 may project an image onto a place other than the wall surface 28 and, specifically, may project an image onto the cooking table 26 or the like. In this embodiment, for convenience, it is assumed that the cooking table 26 is parallel to an XY plane. The XY plane is a plane parallel to an X axis and a Y axis. An axis perpendicular to the wall surface 28 is represented as the Y axis. An axis perpendicular to the Y axis and parallel to the wall surface 28 is represented as the X axis. An axis perpendicular to the X axis and the Y axis is represented as a Z axis. In this embodiment, a direction parallel to the X axis and extending from the sink 24 to the cooking stove 22 in FIG. 1 is represented as a +X direction and a direction opposite to the +X direction is represented as a −X direction. A direction parallel to the Y axis and opposed to a surface to which the projector 1 is fixed on the wall surface 28 in FIG. 1 is represented as a +Y direction and a direction opposite to the +Y direction is represented as a −Y direction. A direction parallel to the Z axis and extending from the projector 1 to the cooking table 26 in FIG. 1 is represented as a +Z direction and a direction opposite to the +Z direction is represented as a −Z direction. In this embodiment, it is assumed that the +Z direction coincides with the vertical direction.

### 1.2. Configuration and Functions of the Projector

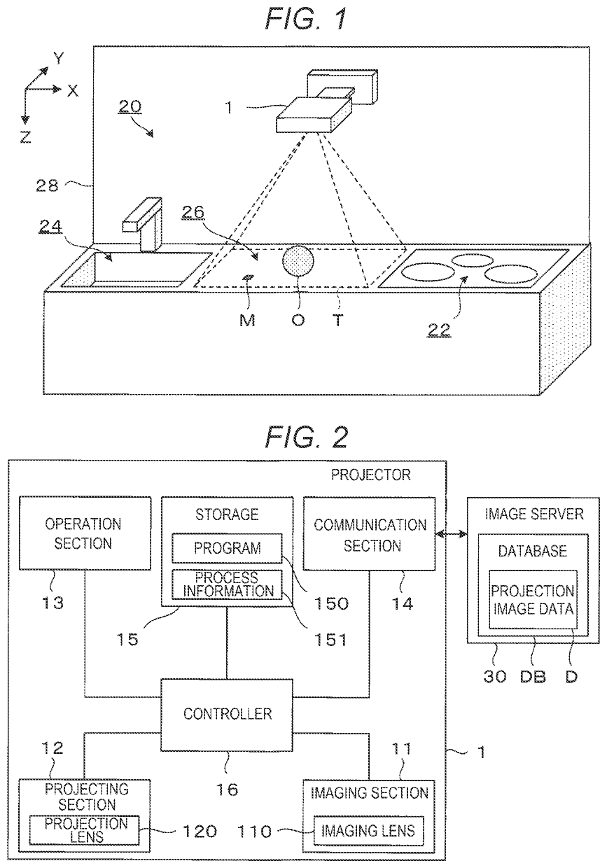

The configuration and functions of the projector 1 according to the first embodiment are explained below with reference to FIGS. 2 to 5.

FIG. 2 is a block diagram showing the configuration of the projector 1 according to the first embodiment. The projector 1 includes the imaging section 11 that images the marker M, the projecting section 12 that projects an image, an operation section 13 that receives input operation from an operator, a communication section 14 that executes communication with an external server and the like, a storage 15 that stores various kinds of information, and the controller 16 that controls the operation of the projector 1.

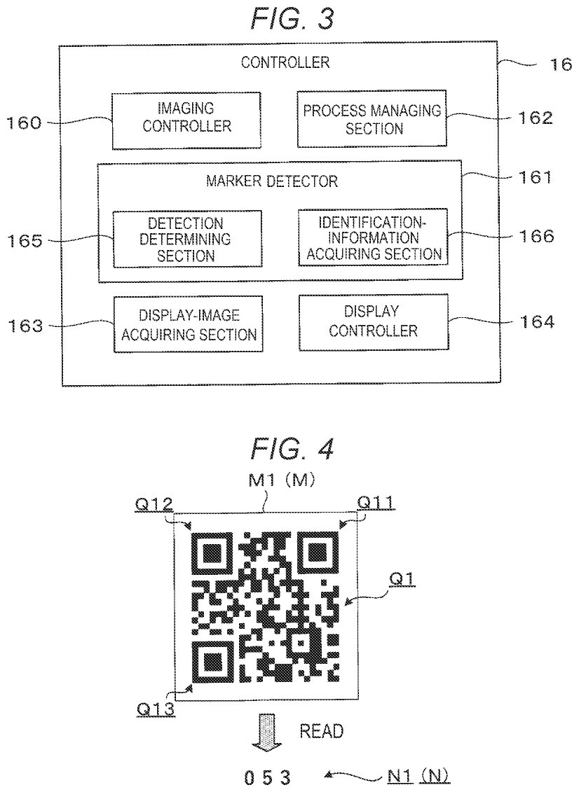

FIG. 3 is a block diagram showing a functional configuration of the controller 16 according to the first embodiment. The controller 16 has functions of an imaging controller 160, a marker detector 161, a process managing section 162, a display-image acquiring section 163, and a display controller 164. The marker detector 161 has functions of a detection determining section 165 and an identification-information acquiring section 166.

The storage 15 includes, for example, a volatile memory such as a RAM and a nonvolatile memory such as a RCM. RAM is an abbreviation of Random Access Memory and ROM is an abbreviation of Read Only Memory. The nonvolatile memory included in the storage 15 stores a program 150 for specifying the operation of the projector 1, the process information 151 for specifying order for displaying images, and the like. The volatile memory included in the storage 15 is used by the controller 16 as a work area in executing the program 150. A part or the entire storage 15 may be provided in an information terminal such as a smartphone, an external storage device, or an external server.

The controller 16 includes one or a plurality of processors. Examples of the processors include a CPU. However, the controller 16 may include a programmable logic device such as an FPGA instead of the CPU or in addition to the CPU. CPU is an abbreviation of Central Processing Unit. FPGA is an abbreviation of Field-Programmable Gate Array.

The CPU or the like included in the controller 16 executes the program 150 and operates according to the program 150, whereby the controller 16 functions as the imaging controller 160, the marker detector 161, the process managing section 162, the display-image acquiring section 163, and the display controller 164 shown in FIG. 3. The marker detector 161 functions as, specifically, the detection determining section 165 and the identification-information acquiring section 166.

At least a part of the functions of the controller 16 may be included in an information terminal or the like such as a smartphone. For example, when the smartphone has at least a part of the functions of the controller 16, the projector 1 is communicably connected to the smartphone having at least a part of the functions of the controller 16 and transmits and receives various kinds of information to and from the smartphone. The smartphone having at least a part of the functions of the controller 16 controls at least a part of the operation of the projector 1.

The operation section 13 receives input operation to the projector 1 from the operator. The operation section 13 may include, for example, a touch panel or operation buttons in a housing of the projector 1. When the operation section 13 includes the touch panel, the operation section 13 outputs data indicating a detected touch position to the controller 16. When the operation section 13 includes the operation buttons, the operation section 13 outputs data for identifying a pressed button to the controller 16. Consequently, content of the input operation of the operator to the projector 1 is transmitted to the controller 16. In this embodiment, it is assumed that the operation section 13 includes the touch panel.

The operation section 13 may be a remote controller that communicates with the projector 1 by infrared rays or the like. In the projector 1, the functions of the operation section 13 may be realized by determining, from a finger or the like of the operator included in a captured image acquired by the imaging section 11 or the like explained below, a position in the imaging region T pointed by the operator. The operation section 13 may receive input operation by a gesture by detecting a movement of the operator with the imaging section 11, a not-shown infrared sensor, or the like.

The communication section 14 includes, for example, an interface substrate including a connector and an interface circuit and has a function of receiving various kinds of information from an information terminal such as a smartphone, an external storage device, an external server, or the like and a function of transmitting various kinds of information to the information terminal such as the smartphone, the external storage device, the external server, or the like. In this embodiment, the communication section 14 is communicably connected to an image server 30 and transmits and receives various kinds of information to and from the image server 30. A database DB in which a plurality of projection image data D are stored is provided in the image server 30. The communication section 14 transmits, according control by the controller 16, an image transmission request for requesting transmission of the projection image data D to the image server 30. The communication section 14 receives the projection image data D transmitted from the image server 30 and outputs the projection image data D to the controller 16.

The imaging section 11 is, for example, a camera including a not-shown imaging element that converts condensed light into an electric signal and an imaging lens 110. The imaging element is, for example, an image sensor, an example of which is a CCD or a CMOS. CCD is an abbreviation of Charge Coupled Device. CMOS is an abbreviation of Complementary Metal Oxide Semiconductor. The imaging lens 110 is provided on a surface of the projector 1 opposed to the cooking table 26. The imaging section 11 images the imaging region T set on the cooking table 26 to acquire a captured image. The captured image is output to the controller 16 as captured image data indicating the captured image.

The imaging section 11 only has to be configured to be capable of acquiring one of a still image and a moving image. In this embodiment, for convenience, it is assumed that the imaging section 11 acquires a still image. The imaging section 11 may be provided on the outside of the projector 1 and, specifically, may be fixed to the outer side of the housing of the projector 1. The imaging section 11 may be, for example, a camera included in a mobile terminal with camera such as a smartphone. For example, when the imaging section 11 is the camera included in the smartphone, the projector 1 is communicably connected to the smartphone including the imaging section 11 and acquires captured image data indicating a captured image from the smartphone.

The imaging controller 160 controls the imaging section 11 and causes the imaging section 11 to image the imaging region T to acquire a captured image. The imaging controller 160 controls, for example, timing of imaging, adjustment a focus, and sensitivity of the imaging element in the imaging section 11. The imaging controller 160 acquires captured image data indicating the captured image from the imaging section 11.

For example, as explained above, when the smartphone has at least a part of the functions of the controller 16 and the function is a function of the imaging controller 160, the smartphone controls the imaging section 11 and causes the imaging section 11 to image the imaging region T to acquire a captured image. The smartphone acquires captured image data indicating the captured image from the imaging section 11.

The marker detector 161 determines, based on the captured image data, whether the marker M is imaged in the acquired captured image. When the marker M is imaged in the captured image, the marker detector 161 sometimes acquires the identification information N recorded in the marker M.

FIG. 4 is an explanatory diagram showing an example of the marker N according to the first embodiment. It is assumed that a marker M1, which is an example of the marker M, is a plate-like tag of approximately several centimeters square including a front surface shown in FIG. 4 and a not-shown rear surface.

A two-dimensional code such as a QR code Q1 in which identification information N1 is recorded is engraved on the front surface of the marker M1. The QR code Q1 includes a finder pattern formed by three squares detecting the position of the QR code Q1. The three squares forming the finder pattern are referred to as segmentation symbols Q11, Q12, and Q13. The segmentation symbols Q11, Q12, and Q13 are respectively disposed at different three corners among the four corners of the QR code Q1. In this embodiment, the detection determining section 165 included in the marker detector 161 determines whether the marker PH, specifically, the QR code Q1 included in the marker M1 is imaged in a captured image. When a result of the determination is affirmative, that is, when the QR code Q1 is imaged in the captured image, the identification-information acquiring section 166 included in the marker detector 161 sometimes reads the QR code Q1 to acquire the identification information N10. “QR code” is a registered trademark.

The identification information N is information for causing the projector 1 to display an image concerning certain specific work. In other words, the identification information N is information for identifying a type of work indicated by the image displayed by the projector this specification, “work” means a set of one or a plurality of procedures performed for a certain purpose. The projector 1 acquires the identification information N to acquire, from the image server 30, the projection image data D for displaying an image concerning a certain procedure in work corresponding to the identification information N and projects a projection image Img based on the projection image data D onto the wall surface 28. For example, it is assumed that the identification information N1 acquired when the QR code Q1 included in the marker M1 shown in FIG. 4 is read is a character string “053” for displaying an image concerning cooking work for “sauteed saury”. This embodiment is explained below with reference to the cooking work as an example. However, the work may be work other than the cooking such as machining.

It is preferable that a food name, in other words, a description concerning a type of the cooking work should be engraved on the rear surface of the marker M1. That is, the operator can identify, by checking the rear surface of the marker M1, which work an image displayed by reading the QR code Q1 engraved on the marker M1 concerns. A description other than the food name or the type of the cooking work may be engraved on the rear surface of the marker M1. A description such as a precaution in imaging the marker M1, for example, “please put the marker within the range of the imaging region” may be engraved.

The process managing section 162 refers to the process information 151 stored in the storage 15 and generates the latest process information 151 corresponding to the identification information N acquired by the identification-information acquiring section 166. The process managing section 162 stores the generated latest process information 151 in the storage 15.

The process managing section 162 generates first process information 151 when the identification-information acquiring section 166 acquires the identification information N first after the projector starts an operation. Thereafter, in a state in which the projector 1 satisfies certain fixed conditions, the process managing section 162 updates the process information 151 every time the identification-information acquiring section 166 acquires the identification information N. In this specification, after the identification-information acquiring section 166 acquires the identification information N, in the state in which the projector 1 satisfies the certain fixed conditions, when the identification-information acquiring section 166 acquires the identification information N, this is referred to as “acquire the identification information N again”. The certain fixed conditions that the projector 1 needs to satisfy when acquiring the identification information N again are sometimes referred to as “re-acquisition conditions”. In this embodiment, the re-acquisition conditions include a condition that the projector 1 acquires the identification information N1 from the marker M1 and a condition that there is a period that is started after the identification information N1 is acquired and in which the identification information N1 is not acquired by the projector 1.

The process information 151 is information for specifying order for displaying images when the projector 1 displays an image concerning a procedure of the work corresponding to the identification information N. For example, when the latest process information 151 stored in the storage 15 is a character string including a number “002” for displaying an image corresponding to a second procedure in the cooking work for “sauteed saury”, the process information 151 generated anew by the process managing section 162 is information for displaying an image corresponding to a third procedure in the cooking work for “sauteed saury” and, specifically, Is represented by a character string “003”. That is, the process information 151 is information for displaying images as indicated by order when an image concerning a certain procedure is switched to an image concerning a procedure performed later than the certain procedure in the work corresponding to the identification information N. When the latest process information 151 is the first process information 151 generated by the process managing section 162, the first process information 151 is information for displaying an image corresponding to a first procedure in the cooking work for “sauteed saury” and, specifically, is represented by a character string “001”.

The process managing section 162 generates, from the identification information N and the process information 151, image identification information tic used in acquiring necessary projection image data D from the image server 30. For example, when the projector 1 displays the image corresponding to the second procedure in the cooking work for “sauteed saury”, the process managing section 162 generates image identification information Nc2 including a character string “053_002” from. the character string “053” corresponding to the cooking work for “sauteed saury” and the character string “002” corresponding to the second procedure in the cooking work for “sauteed saury”.

The display-image acquiring section 163 controls the communication section 14 to inquire the image server 30 whether the projection image data D corresponding to the image identification information Nc generated by the process managing section 162 is stored in the image server 30. When desired projection image data D is stored in the image server 30, the display-image acquiring section 163 controls the communication section 14 to acquire the projection image data D from the image server 30. Specifically, the display-image acquiring section 163 transmits an image transmission request including the image identification information Nc to the image server 30. The image server 30 transmits the projection image data D specified by the image identification information No to the projector 1.

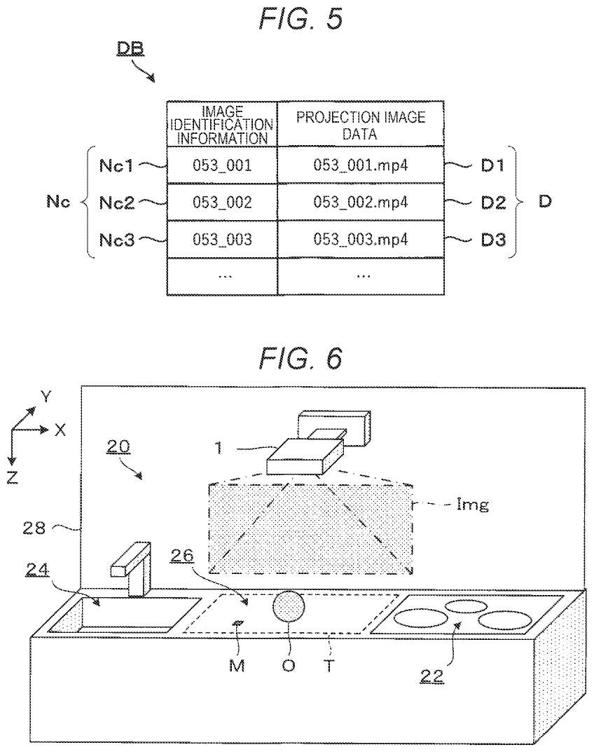

FIG. 5 is an explanatory diagram schematically showing' the database DB provided in the image server 30. A plurality of projection image data D are saved in the database DB. The projection image data D is managed in association with. the image identification information Nc. For example, it is preferable that the image server 30 should be able to specify a storage region of the projection image data D corresponding to the image identification information Nc by searching through the database DB using the image identification information Nc as an index. A character string indicating the image identification information Nc may be included in a part or all of file names included in the projection image data D. In this embodiment, it is assumed that, for example, projection image data D1 having a file name “053_001.mp4”, projection image data D2 having a file name “053_002.mp4”, and projection image data D3 having a file name “053_003.mp4” are saved in the database DB. As shown in FIG. 5, it is seen that the projection image data D corresponding to image identification information Nc1 including a character string “053_001” is the projection image data D1 having the file name “053_001.mp4”, the projection image data corresponding to image identification information Nc2 including a character string “053_002” is the projection image data D2 having the file name “053_002.mp4”, and the projection image data D corresponding to image identification information Nc3 including a character string “053_003” is the projection image data D3 having the file name “053_003.mp4”. Accordingly, for example, when the image corresponding to the second procedure in the cooking work for “sauteed saucy” is displayed, the display-image acquiring section 163 acquires the projection image data D2 corresponding to the second procedure from the image server 30 using the image identification information Nc2 generated. as explained above.

The projection image data D may be still image data having an extension such as “mpg” or may be moving image data having an extension such as “mp4”. In this embodiment, it is assumed that the projection image data D is the moving image data having the extension “mp4”.

The display controller 164 controls the projecting section 12 and causes the projecting section 12 to display, on the wall surface 28, the projection image Img based on the projection image data D acquired by the display-image acquiring section 163. The display controller 164 controls the projecting section 12 such that, for example, a shape, a color tone, or the like of the projection image Img is appropriately displayed.

The projecting section 12 includes a light source device including a halogen lamp, a xenon lamp, an ultrahigh pressure mercury lamp, an LED, or a laser light source, an optical modulator that generates image light, and a projection optical system that projects the image light. The optical modulator includes a DMD or a liquid crystal panel. The projection optical system includes a projection lens 120. LED is an abbreviation of Light Emitting Diode. DMD is an abbreviation of Digital Mirror Device. The projecting section 12 projects the projection image Img onto the wall surface 28 based on the projection image data D output from the display controller 164.

### 1.3. A Display Method for the Projection Image and an Acquiring Method for the Identification Information

A display method for the pro comic image Img and an acquiring method for the identification information N according to the first embodiment are explained with reference to FIGS. 6 to 11.

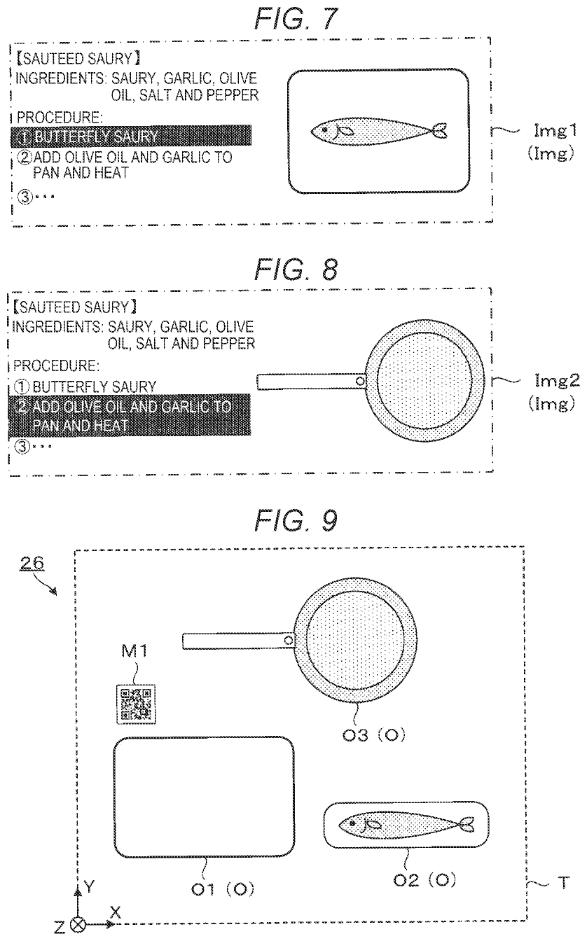

FIG. 6 is a schematic diagram illustrating a state of image projection of the projector 1 according to the first embodiment. FIGS. 7 and 8 are schematic diagrams showing an example of the projection image Img. FIG. 7 is an image corresponding to the first procedure in the cooking work for “sauteed saury” and, specifically, is a projection image Img1 based on the projection image data D1 having the file name “053_001.mp4”. FIG. 8 is an image corresponding to the second procedure in the cooking work for “sauteed saury” and, specifically, is a projection image Img2 based on the projection image data D2 having the file name “053_002.mp4”.

The projector 1 images the marker M. The projector 1 detects the marker N from a captured image. The projector 1 acquires the identification information N from the marker M. The projector 1 acquires the identification information N in a state in which the re-acquisition conditions are satisfied to update the process information 151. The projector 1 generates the image identification information Nc from the identification information N and the process information 151. The projector 1 acquires the projection image data D from the image server 30 using the image identification information Nc. As shown in FIG. 6, the projector 1 projects the projection image Img based on the projection image data D onto the wall surface 28. For example, in the first embodiment, when the identification-information acquiring section 166 acquires the identification information N1 represented by the character string “053” from the marker M1 first, the first process information 151 generated by the process managing section 162 is, as explained above, the information for displaying the image corresponding to the first procedure in the cooking work for “sauteed saury” and, specifically, is represented by the character string “001”. Accordingly, the projector 1 projects the projection image Img1 based on the projection image data D1 having the file name “053_001.mp4” onto the wall surface 28. Thereafter, when the identification-information acquiring section 166 acquires the identification information N1 from the marker M1 in a state in which the projector 1 satisfies the re-acquisition conditions, the latest process information 151 generated by the process managing section 162 is the information for displaying the image corresponding to the second procedure in the cooking work for “sauteed saury” and, specifically, is represented by the character string “002”. Accordingly, the projector 1 projects the projection image Img2 based on the projection image data D2 having the file name “053_002.mp4” onto the wall surface 28. That is, by acquiring the identification information N1 in the state in which the re-acquisition conditions are satisfied, in other words, by acquiring the identification information N again, the projector 1 according to this embodiment can switch an image to be displayed. An image before the display is switched is an image concerning a certain procedure in the work corresponding to the identification information N. An image after the display is switched is an image concerning a procedure performed later than the certain procedure. Consequently, the projector 1 can display, as indicated by the order of the work, images concerning the procedure of the work corresponding to the identification information N according to an increase in the number of times the identification information N is acquired again.

When the projection image Img is a moving image, The projector 1 may repeatedly reproduce The moving image until the image to be displayed is switched. When no projection image data D corresponding to the image identification information Nc is left in the image server 30 because all of the projection image data D corresponding to the procedures in the work corresponding to the identification information N are displayed, the projector 1 may end the display of the image.

FIGS. 9 to 11 are schematic diagrams for explaining an acquiring method for the identification information N in the projector 1 according to the first embodiment. FIGS. 9 to 11 are schematic diagrams of the imaging region T on the cooking table 26 and the vicinity of the imaging region T in a plan view from the −Z direction to the +Z direction. As examples of the object O, a chopping board O1, a saury O2, and a pan O3 are disposed within the range of the imaging region T.

In this embodiment, the re-acquisition conditions include a condition that the projector 1 acquires the identification information N1 from the marker M1 and a condition that there is a period that is started after the identification information N1 is acquired and in which the identification information is not acquired by the projector 1. That is, it is assumed that the projector 1 acquires the identification information N1 after the period that is started after the identification information N1 is acquired and in which the identification information N1 is not acquired to switch an image to be displayed by the projector 1. As a specific example, in a case explained below, the image to be displayed by the projector 1 is switched by executing disposing the marker M1 within the range of the imaging region T to cause the projector 1 to detect the marker M1, after causing the projector 1 to detect the marker M1, disposing the marker M1 outside the range of the imaging region T not to cause the projector 1 to detect the marker M1, and, after not causing the projector 1 to detect the marker M1, disposing the marker M1 within the range of the imaging region T again to cause the projector 1 to detect the marker M1.

As shown in FIG. 9, the operator disposes the marker M1 within the range of the imaging region T. The imaging controller 160 controls the imaging section 11 and causes the imaging section 11 to image the imaging region T to acquire a captured image including the marker M1. Thereafter, the detection determining section 165 included in the marker detector 161 determines whether the marker M1 is imaged in the captured image. The identification-information acquiring section 166 included in the marker detector 161 reads the QR code Q1 in the marker M1. to acquire the identification information N1. The identification information N1 is, as explained above, the character string “053” for displaying an image concerning the cooking work for “sauteed saury”. The process managing section 162 generates the latest process information 151 corresponding to the identification information N1. It is assumed that the latest process, information 151 generated by the process managing section 162 is the character string “001”. In addition, the process managing section 162 stores the latest process information 151 including the character string “001” in the storage 15. The process managing section 162 generates the image identification information Nc1 from the identification information N1 and the latest process information 151. As explained above, the image identification information Nc1 is the character string “053_001”. Thereafter, the display-image acquiring section 163 searches through the database DB provided in the image server 30 to acquire the projection image data D1 corresponding to the image identification information Nc1. The display controller 164 displays the projection image Img1 based on the projection image data D1.

As shown in FIG. 10, the operator moves the marker M1 to the outside of the range of the imaging region T. The imaging controller 160 controls the imaging section 11 and causes the imaging section 11 to image the imaging region T to acquire a captured image not including the marker M1. Thereafter, the detection determining section 165 determines that the marker N is not imaged in the captured image. That is, a period in which the identification information N1 is not acquired after the identification-information acquiring section 166 acquires the identification information N1 is started.

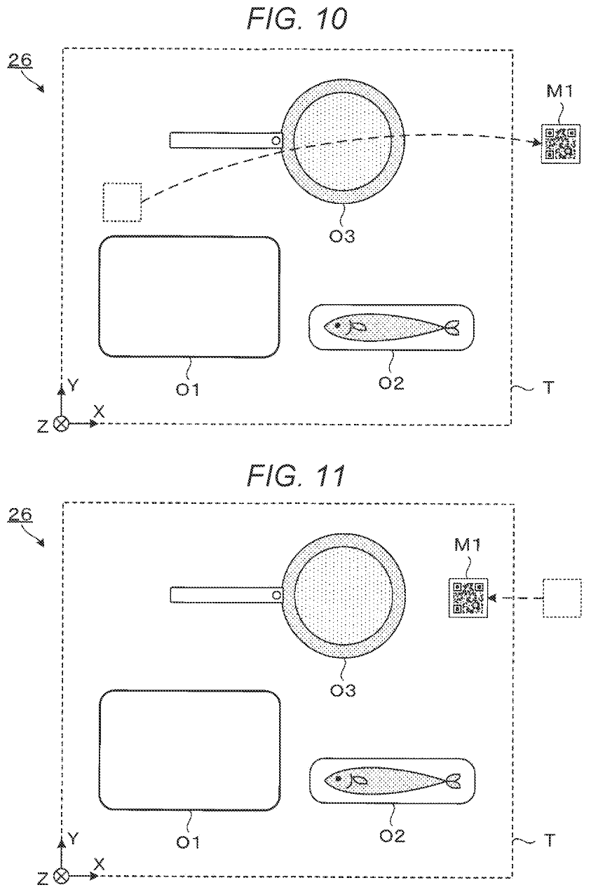

As shown in FIG. 11, the operator moves the marker M1 to the inside of the range of the imaging region T. The imaging controller 160 controls the imaging section 11 and causes the imaging section 11 to image the imaging region T to acquire a captured image including the marker M1. Thereafter, the detection determining section 165 determines that the marker M is imaged in the captured image. The projector 1 achieves acquiring the identification information N1 from the marker M1 and having a period that is started after the identification information N1 is acquired and in which the identification information N1 is not acquired, that is, the projector 1 satisfies the re-acquisition conditions. Therefore, the identification-information acquiring section 166 reads the QR code Q1 included in the marker M1 to acquire the identification information N1 again. The process managing section 162 updates the latest process information 151 corresponding to the identification information N1. The latest process information 151 updated by the process managing section 162 is the character string “002” generated by referring to the character string “001” stored in the storage 15. The process managing section 162 stores the latest process information 151 including the character string “002” in the storage 15. The process managing section 162 Generates the image identification information Nc2 from the identification information N1 and the latest process information 151. The image identification information Nc2 is, as explained above, the character string “053_002”. Thereafter, the display-image acquiring section 163 searches through the database DB provided in the image server 30 to acquire the projection image data D2 corresponding to the image identification information Nc2. The display controller 164 switches the image be displayed from the projection image Img1 to the projection image Img2 based on the projection image data D2.

As explained above, the projector 1 according to the first embodiment can switch the displayed projection image Img by acquiring the identification in N1 from the marker M1 and, after the period that is started after the identification information N1 is acquired and in which the identification information N1 is not acquired, acquiring the identification information N1 again.

As means for preventing the projector 1 from acquiring the identification information N1, instead of moving the marker M1 to the outside of the range of the imaging region T, the projector 1 may be prevented from reading the marker M1 while keeping the marker M1 disposed within the range of the imaging region T. As the means for preventing the projector 1 from acquiring the identification information N, for example, a shielding object may be provided between the marker M1 and the projector 1 and, specifically, the marker M1 may be covered by an earthenware cup or the like.

### 1.4. Operation of the Projector

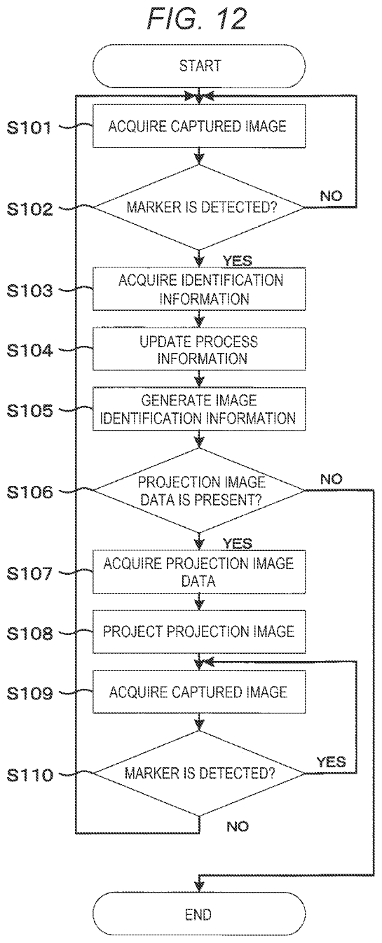

FIG. 12 is a flowchart for explaining the operation of the projector 1 according to the first embodiment. A series of operations shown in the flowchart is started, for example, when the projector 1 is turned on and the operation section 13 receives input operation concerning an operation start from the operator.

In step S101, the imaging controller 160 causes the imaging section 11 to image the imaging region T to acquire a captured image. Thereafter, the imaging controller 160 acquires captured image data indicating the captured image from the imaging section 11.

In step S102, the detection determining section 165 included in the marker detector 161 determines whether the marker M1, specifically, the QR code Q1 included in the marker M1 is imaged in the captured image. When determining in step S102 that the QR code Q1 included in the marker M1 is imaged in the captured image, that is, when determining YES in step S102, the detection determining section 165 advances the processing to step S103. When determining in step S102 that the QR code Q1 included in the marker M1 is not imaged in the captured image, that is, when determining NO in step S102, the detection determining section 165 advances the processing to step S101.

In step S103, the identification-information acquiring section 166 included in the marker detector 161 reads the QR code Q1 to acquire the identification information N1.

In step S104, the process managing section 162 updates the process information 151. That is, the process managing section 162 refers to the process information 151 stored in the storage 15 and generates the latest process information 151 corresponding to the identification information N1. The process managing section 162 stores the generated latest process information 151 in the storage 15.

When the process in step S104 is executed first after the projector 1 starts the operation or when the process information 151 is not stored in the storage 15 when the processing in step S104 is executed, the generated latest process information 151 may be information for displaying an image corresponding to a first procedure in the work corresponding to the identification information N1. For example, when the process information 151 stored in the storage 15 is a character string including a numerical value of a value k, the process managing section 162 may generate, as the latest process information 151, a character string including a numerical value obtained by adding 1 to the value k. The value k is an integer equal to or larger than 1.

In step S105, the process managing section 162 generates the image identification information Nc from the identification information N1 acquired from the marker M1 and the latest process information 151 stored in the storage 15.

In step S106, the display-image acquiring section 163 controls the communication section 14 to inquire the image server 30 whether the projection image data D corresponding to the image identification information Nc generated by the process managing section 162 is stored in the image server 30. When desired projection image data D is stored in the image server 30 in step S106, that is, in the case of YES in step S106, the display-image acquiring section 163 advances the processing to step S107. When the desired projection image data D is not stored in the image server 30 step S106, that is, in the case of NO in step S106, the controller 16 including the display-image acquiring section 163 ends the series of operations shown in the flowchart.

In the case of NO in step S106, it is seen that the projection image data D corresponding to the image identification information Nc is not saved in the database DB provided in the image server 30. This is because, for example, the projector 1 has displayed all of the projection image data D corresponding to the procedures in the cooking work for “sauteed saury” corresponding to the identification information N1. In this case, there is no more procedure in the cooking work.

In step S107, the display-image acquiring section 163 controls the communication section 14 to acquire the projection image data D corresponding to the image identification information Nc from the image server 30.

In step S108, the display controller 164 causes the projecting section 12 to display the projection image Img based on the projection image data D on the wall surface 28.

In step S109, the imaging controller 160 causes the imaging section 11 to image the imaging region T to acquire a captured image. Thereafter, the imaging controller 160 acquires captured image data indicating the captured image from the imaging section 11.

In step S110, the detection determining section 165 included in the marker detector 161 determines whether the marker M1, specifically, the QR code Q1 included in the marker M1 is imaged in the captured image. When determining in step S110 that the QR code Q1 included in the marker M1 is imaged in the captured image, that is, when determining YES in step S110, the detection determining section 165 advances the processing to step S109. When determining in step S110 that the QR code Q1 included in the marker M1 is not imaged in the captured image, that is, when determining NO in step S110, the detection determining section 165 advances the processing to step S101.

When it is determined YES in step S110, the marker M1 is kept disposed within the range of the imaging region T from the determination in step S102 until the determination in step S110 and is regarded as not moving to the outside of the range of the imaging region T.

When it is determined NO in step S110, the QR code Q1 is regarded as not being imaged in the acquired captured image or the QR code Q1 in the captured image is regarded as not being able to be read. That is, a period in which the identification information N1 is not acquired after the identification-information acquiring section 166 acquires the identification information N1 in step S103 is started. The period in which the identification information N1 is not acquired is continued from when it is determined NO in step S110 until when it is determined YES in step S102.

When it is determined YES in step S110, instead of advancing the processing to step S109, the controller 16 may perform. processing for reading the QR code Q1 to acquire the identification information N1. After performing the processing for reading the QR code Q1 to acquire the identification information N1, the controller 16 advances the processing to step S109.

The flowchart of FIG. 12 is repeatedly processed until it is determined NO in step S105. In the flowchart of FIG. 12, every time the controller 16 executes the processing in step S103 through the processing in step S110, the projector 1 acquires the identification information N1 again. The latest process information 151 is updated every time the controller 16 executes the processing in step S104. The projection image Img projected from the projector 1 is switched every time the controller 16 executes the processing in step S106.

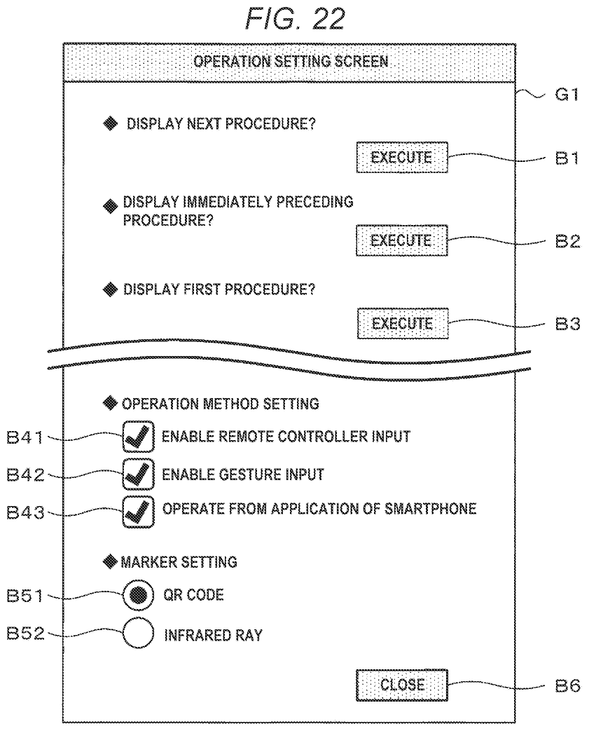

FIG. 22 is an explanatory diagram snowing an example of a display screen in the operation section 13 of the projector 1 according to the first embodiment. As explained above, in this embodiment, it is assumed that the operation section 13 includes the touch panel. A screen G1 is an example of a screen displayed on the touch panel and, specifically, is a screen displayed when inputs concerning the operation, setting, and the like of the projector 1 are performed.

As shown in FIG. 22, the screen G1 includes a button B1, a button B2, and a button B3. The button B1 is a button for designating execution of an operation for switching an image displayed by the projector 1 from an image concerning a certain procedure in the work corresponding to the identification information N to an image concerning a procedure performed later than the certain procedure. The button B2 is a button for designating execution of an operation for switching the image displayed by the projector 1 from an image concerning a certain procedure in the work corresponding to the identification information N to an image concerning a procedure performed earlier than the certain procedure. The button B3 is a button for designating execution of an operation for switching the image displayed by the projector 1 from an image concerning a certain procedure in the work corresponding to the identification information N to an image concerning a first procedure in the work corresponding to the identification information N.

When the button B1 is pressed, the controller 16 ends the operation being executed and, in a state in which the latest process information 151 is maintained, resumes the operation from step S101 of the flowchart of FIG. 12. That is, in this embodiment, the pressing the button B1 is an input for instructing the controller 16 to acquire a captured image, in other words, an input for instructing the controller 16 to acquire the identification information N1 again. Since it is necessary to image the marker M1 to acquire the identification information N1, it is preferable that, when the button B1 is pressed, the operation section 13 should display, on1 the touch panel, a message for instructing the controller 16 to dispose the marker M1 within the range of the imaging region T.

When the button B2 is pressed, the controller 16 ends the operation being executed, refers to the latest process information 151 stored in the storage 15, generates the process information 151 for displaying an image corresponding to a procedure immediately preceding a procedure corresponding to the latest process information 151, and stores the generated process information 151 in the storage 15 as the latest process information 151. The controller 16 resumes the operation from step S105 of the flowchart of FIG. 12. That is, in this embodiment, the pressing the button B2 is an input for instructing the controller 16 to switch an image to be displayed from an image concerning a certain procedure in the work corresponding to the identification information N1 to an image concerning a procedure performed immediately before the certain procedure.

When the button B3 is pressed, the controller 16 ends the operation being executed and stores, as the latest process information 151, in the storage 15, information for displaying an image corresponding to a first procedure in the work corresponding to the identification information N1. The controller 16 resumes the operation from step S105 of the flowchart of FIG. 12. That is, in this embodiment, the pressing the button B3 is an input for instructing the controller 16 to switch an image to be displayed from an image concerning a certain procedure in the work corresponding to the identification information N1 to the image concerning the first procedure in the work corresponding to the identification information N1. When the button B3 is pressed, the controller 16 may erase the process information 151 of the storage 15 and resume the operation from step S101 of the flowchart of FIG. 12.

As shown in FIG. 22, the screen G1 includes checkboxes B41, B42, and B43 for performing setting concerning a method for input operation to the projector 1. When the checkbox B41 is checked, the projector 1 may receive input operation from a not-shown remote controller besides the touch panel included in the operation section 13. In this case, the remote controller is equivalent to the operation section 13. When the checkbox B42 is checked, the projector 1 may receive input operation by a gesture of the operator besides the touch. panel included in the operation section 13. When the checkbox B43 is checked, the projector 1 may receive input operation performed by using a smartphone besides the touch panel included in the operation section 13.

In this embodiment, when at least one of the checkboxes B41, B42, and B43 is checked, the projector 1 may receive input operation from a device other than the touch panel included in the operation section 13. For example, when the checkbox B41 is checked, the projector 1 may receive input operation by pressing of the buttons B1 to B3 from the remote controller.

As shown in FIG. 22, the screen G1 includes radio buttons B51 and B52 for performing setting concerning a type of the marker M to be used. When the radio button B51 is selected, for example, a tag engraved with a QR code in which the identification information N is recorded, an example of which is the marker M1 according to this embodiment, is used as the marker M. When the radio button B52 is selected, for example, a module that includes an infrared LED and flashes the LED at a predetermined interval to transmit the identification information N is used as the marker M.

As shown in FIG. 22, the screen G1 includes a button B6 for ending the input operation to the projector 1. When the button B6 is pressed, the operation section 13 ends the display of the screen G1.

From the above, according to the first embodiment, the projector 1 acquires the identification information N1 from the marker M1 and, after the period that is started after the identification information N1 is acquired and in which the identification information N1 is not acquired, acquires the identification information N1 again. Therefore, the projection image Img to be displayed by the projector 1 can be switched. Accordingly, the operator can display, as indicated by the order of the work, images concerning the procedure of the work corresponding to the identification information N1 according to an increase in the number of times die projector 1 acquires the identification information N1 again.

According to the first embodiment, by causing the projector 1 to acquire the identification information M1 using die marker M1, it is possible to cause the projector 1 to display an image concerning the procedure of the work corresponding to the identification information N1. Accordingly, the operator can cause the projector 1 to acquire the identification information N1 at any timing by operating the marker M1, in other words, can switch the projection image Img at any timing. By recording the identification information N corresponding to different kinds of work respectively in a plurality of markers M, the operator can easily display images concerning procedures of a plurality of kinds of work only by replacing the marker M.

According to the first embodiment, by controlling the operation of the projector 1 using the button B1, the button B2, and the button B3, it is possible to optionally switch the projection image Img displayed by the projector 1. Accordingly, the operator can display an image concerning a desired procedure irrespective of the progress of work. For example, even when the projection image Img is switched by mistake, by using the button B2, the operator can restore the projection image Img to be displayed. When the processing proceeds to a procedure performed later than the procedure indicated by the projection image Img, by using the button B1, the operator can display an image concerning a desired procedure without operating the marker M1.

As explained above, the display method according to the first embodiment includes acquiring the identification information N1 from the marker M1 in which the identification information N1 is recorded, displaying the projection image Img1 concerning a first procedure in the cooking work for “sauteed saury” corresponding to the identification information N1, after the displaying the projection image Img1 concerning the first procedure, acquiring the identification information N1 from the marker M1 again, and, after the acquiring the identification information N1 again, displaying the projection image Img2 concerning a second procedure performed later than the first procedure the cooking work for “sauteed saury” corresponding to the identification information N1.

The display system according to the first embodiment includes the imaging section 11, the projecting section 12, and the controller 16 that controls the imaging section 11 and the projecting section 12. The controller 16 executes controlling the imaging section 11 to thereby, acquire the identification information N1 from the marker M1 in which the identification information N1 is recorded, controlling the projecting section 12 to thereby display the projection image Img1 concerning a first procedure in the cooking work for “sauteed saury” corresponding to the identification information N1, after the displaying the projection image Img1 concerning the first procedure, controlling the imaging section 11 to thereby acquire the identification information N1 from the marker M1 again, and, after the acquiring the identification information N1 again, controlling the projecting section 12 to thereby display the projection image Img2 concerning a second procedure performed later than the first procedure in the cooking work for “sauteed saury” corresponding to the identification information N1.

The program according to the first embodiment instructs the controller 16 to acquire the identification information N1 from the marker M1 in which the identification information N1 is recorded, display the projection image Img1 concerning a first procedure in the cooking work for “sauteed saury” corresponding to the identification information N1, after the displaying the projection image Img1 concerning the first procedure, acquire the identification information N1 from the marker M1 again, and, after the acquiring the identification information N1 again, display the projection image Img2 concerning a second procedure performed later than the first procedure the cooking work for “sauteed saury” corresponding to the identification information N1.

That is, by acquiring the identification information N1 from the marker M1, the projector 1 according to this embodiment can switch an image to be displayed, Consequently, the projector 1 can display, as indicated by the order of the work, images concerning the procedure of the work corresponding to the identification information N1 recorded in the marker M1 according to the number of times the projector 1 acquires the identification information N1 again.

An the first embodiment, the identification information N1 in an example of “first information”, the marker M1 is an example of the “marker”, the cooking work for “sauteed saury” is an example of the “work”, the first procedure is an example of the “first procedure”, the second procedure is an example of the “second procedure”, the imaging section 11 is an example of the “sensor”, the projecting section 12 is an example of the “display device”, and the controller 16 is an example of the “processing device”. The projection image Img1 and the projection image Img2 are examples of the “image”.

In the display method according to the first embodiment, the acquiring the identification information N1 again includes acquiring the identification information N1 after a period that is started after the identification information N1 is acquired and in which the identification information N1 is not acquired.

That is, the operator can switch the projection image Img at any timing by controlling whether to cause the projector 1 to acquire the identification information N1. Consequently, the operator can switch, according to the progress of the work, the projection image Img to be displayed.

The display method according to the first embodiment further includes receiving pressing the button B1 for instructing the controller 16 to acquire the identification information N1 again. The acquiring the identification information N1 again includes acquiring the identification information N1 when receiving the pressing the button B1.

That is, by pressing the button B1, the operator can instruct the controller 16 to acquire the identification information N1 again and can switch the projection image Img at any timing. Consequently, the operator can switch, according to the progress of the work, the projection image Img to be displayed.

In the first embodiment, the pressing the button B1 is an example of the “first input”.

The display method according to the first embodiment further includes, after the displaying the projection image Img2 concerning the second procedure, receiving pressing the button 132 for instructing to display the projection image Img1 concerning the first procedure and, when receiving the pressing the button B2, displaying the projection image Img1 concerning the first procedure.

That is, by pressing the button B2, the operator can switch an image to be displayed from an image concerning a certain procedure in the work corresponding to the identification information N1 to an image concerning a procedure performed immediately before the certain procedure. Consequently, even when the projection image Img is switched by mistake, the operator can restore the projection image Img to be displayed.

In the first embodiment, the pressing the button B2 is an example of the “second input”.

### 2. Second Embodiment

A second embodiment of the present disclosure is explained below. Components having the same action and functions as those in the first embodiment are denoted by the reference numerals and signs used in the explanation of the first embodiment and detailed explanation of the components is omitted as appropriate.

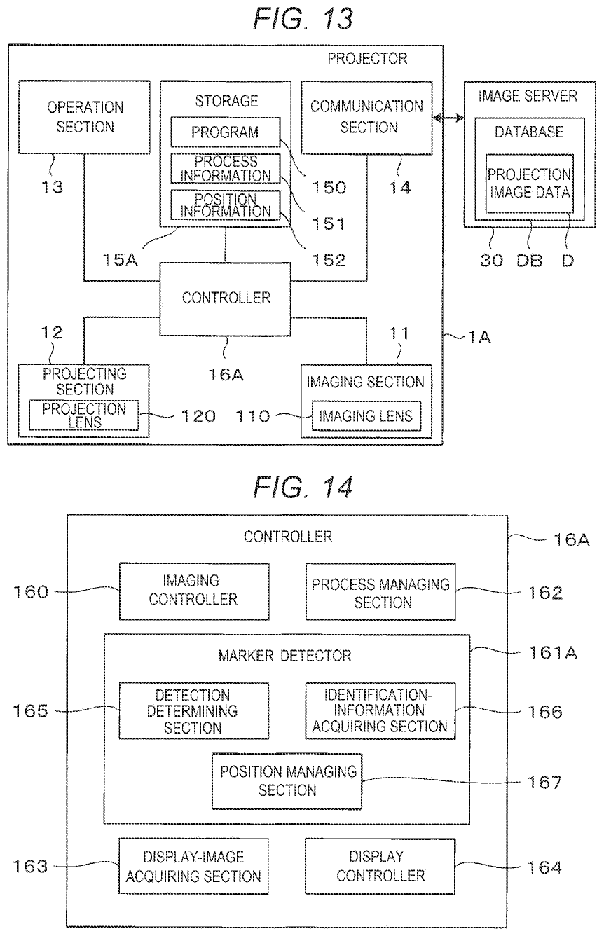

The configuration and functions of a projector 1A according to the second embodiment are explained below with reference to FIGS. 13 and 14.

FIG. 13 is a block diagram showing the configuration of the projector 1A according to the second embodiment. The projector 1A is configured the same as the projector 1 according to the first embodiment except that the projector 1A includes a storage 15A instead of the storage 15 and includes a controller 16A instead of the controller 16. The storage 15A is configured the same as the storage 15 except that the storage 15A stores position information 152 in addition to the program 150, the process information 151, and the like.

FIG. 14 is a block diagram showing a functional configuration of the controller 16A according to the second embodiment. The controller 16A is configured the same as the controller 16 according to the first embodiment except that the controller 16A has a function of a marker detector 161A instead of the marker detector 161. The marker detector 161 is configured the same as the marker detector 161 except that the marker detector 161A has a function of a position managing section 167 in addition to the detection determining section 165 and the identification-information acquiring section 166.

The position information 152 is information concerning a position where the marker M is disposed. The position information 152 may be, for example, information indicating a coordinate of the marker M within the range of the imaging region T. Specifically, a coordinate indicating a geometrical center of the segmentation symbol Q13 among the segmentation symbols Q11, Q12, and Q13 disposed at three corners among the four corners of the QR code included in the marker M1 shown in FIG. 4 may be set as the position information 152.

The position managing section 167 generates the latest position information 152 concerning the imaged marker M from. captured image data acquired by the imaging controller 160. The position managing section 167 stores the generated latest position information 152 in the storage 15A.

In addition, the position managing section 167 refers to the position information 152 stored in the storage 15A and determines whether the latest position information 152 is the same as the first-time position information 152. The first-time position information 152 is the oldest position information 152 stored in the storage 15A.

In this specification, when the marker P is disposed in a position where the position managing section 167 generates the first-time position information 152, the position is sometimes referred to as “first position”. When the marker a is disposed in a position different from the first position, the position different from the first position is sometimes referred to as “second position”. The determining whether the latest position information 152 is the same as the first-time position information 152 is, in other words, determining whether the latest position information 152 is information indicating the first position.

The position information 152, in particular, the first-time position information 152 may be changed as appropriate. For example, the position information 152 may be reset every time the projector 1A is turned on. When only one position information 152 is stored in the storage 15A, the position information 152 is the latest position information 152 and is the first-time position information 152.

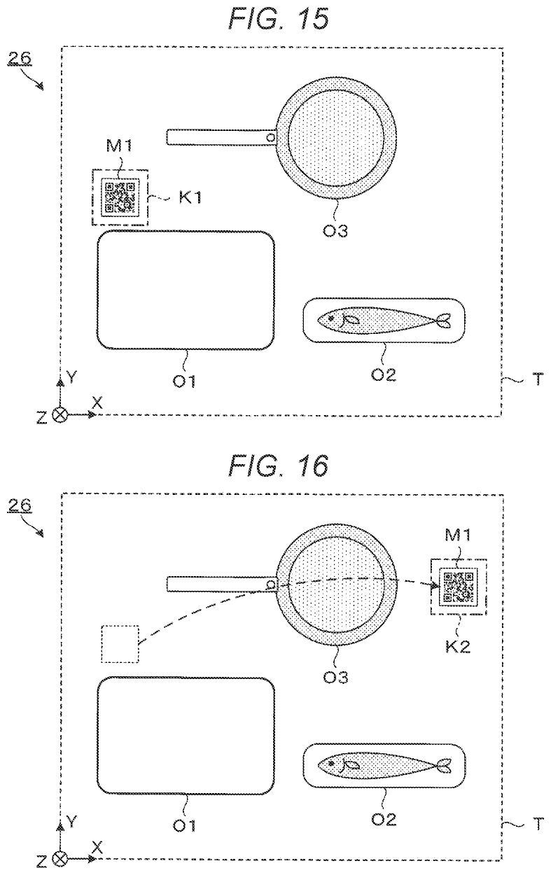

An acquiring method for the identification information N according to the second embodiment is explained with reference to FIGS. 15 to 17.

FIGS. 15 to 17 are schematic diagrams for explaining an acquiring method for the identification information N in the projector 1A according to the second embodiment. Like FIGS. 9 to 11, FIGS. 15 to 17 are schematic diagrams of the imaging region T on the cooking table 26 and the vicinity of the imaging region T in the plan view from the −Z direction to the +Z direction. The chopping board O1, the saury O2, and the pan O3 are disposed within the range of the imaging region T.

In this embodiment, re-acquisition conditions include a condition that the projector 1A acquires the identification information N1 from the marker M1 located in the first position, a condition that, after the identification information N1 is acquired from. the marker M1 located in the first position, the identification information N1 is acquired from the marker M1 located in the second position different from the first position, and a condition that, after the identification information N1 is acquired from the marker M1 located in the second position, the identification information N1 is acquired from the marker M1 located in the first position. That is, it is assumed that, after acquiring the identification information N1 from the marker M1 located in the second position, the projector 1A acquires the identification information N1 from the marker M1 located in the first to switch an image to be displayed by the projector 1A. As a specific example, in a case explained below, the image to be displayed by the projector 1A is switched by executing disposing the marker M1 in a position K1 set within the range of the imaging region T to cause the projector 1A to detect the marker M1, after causing the projector 1A to detect the marker M1 located in the position K1, causing the projector 1A to detect the marker M1 by disposing the marker M1 in a position K2 set within the range of the imaging region T, and, after causing the projector 1A to detect the marker M1 located in the position K2, disposing the marker M1 in the position K1 set within the range of the imaging region T again to cause the projector 1A to detect the marker M1.

As shown in FIG. 15, an operator disposes the marker M1 in the position K1 within the range of the imaging region T. The position K1 is the first position. The imaging controller 160 controls the imaging section 11 and causes the imaging section 11 to image the imaging region T to acquire a captured image including the marker M1. Thereafter, the detection determining section 165 included in the marker detector 161A. determines that the marker M1 is imaged in the captured image. The position managing section 167 included in the marker detector 161A generates, from captured image data acquired by the imaging controller 160, the latest position information 152 concerning the marker M1 disposed in the position K1. The position managing section 167 stores the generated latest position information 152 in the storage 15A. Thereafter, the position managing section 167 refers to the position information 152 stored in the storage 15A and determines whether the latest position information 152 is information indicating the first position. The identification-information acquiring section 166 included in the marker detector 161A reads the QR code Q1 included in the marker M1 located in the position K1 to acquire the identification information N1. The identification information N1 is a character string “053”. The process managing section 162 generates the latest process information 151 corresponding to the identification information N1. It is assumed that the latest process information 151 generated by the process managing section 162 is a character string “001”. In addition, the process managing section 162 stores the latest process information 151 including the character string “001” in the storage 15A. The process managing section 162 generates the image identification information Nc1 from the identification information N1 and the latest process information 151. The image identification information Nc1 is, as explained above, the character string “053_001”. Thereafter, the display-image acquiring section 163 searches through the database DB provided in the image server 30 to acquire the projection image data D1 corresponding to the image identification information Nc1. The display controller 164 displays the projection image Img1 based on the projection image data D1.

As shown in FIG. 16, the operator moves the marker M1 to the position K2 within the range of the imaging region T. The position K2 is the second position. The imaging controller 160 controls the imaging section 11 and causes the imaging section 11 to image the imaging region T to acquire a captured image including the marker M1. Thereafter, the detection determining section 165 determines that the marker M1 is imaged in the captured image. The position managing section 167 generates, from captured image data acquired by the imaging controller 160, the latest position information 152 concerning the marker M1 disposed in the position K2. The position managing section 167 stores the generated latest position information 152 in the storage 15A. Thereafter, the position managing section 167 refers to the position information 152 stored in the storage 15A and determines that the latest position information 152 is not information indicating the first position. The identification-information acquiring section 166 reads the QR code Q1 included in The marker M1 located in the position K2 different from the position K1 to acquire the identification information N1.

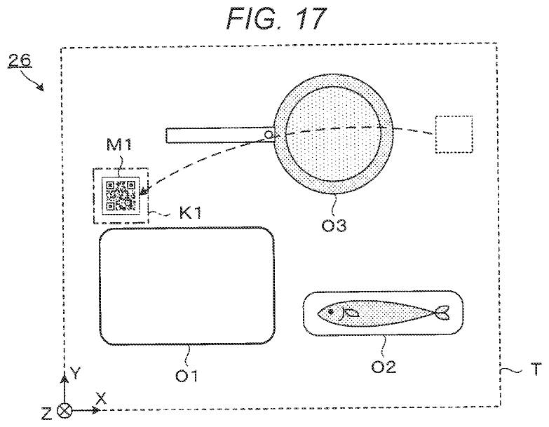

As shown in FIG. 17, the operator moves the marker M1 to the position K1 within the range of the imaging region T. As explained above, the position K1 is the first position. The imaging controller 160 controls the imaging section 11 and causes the imaging section 11 to image the imaging region T to acquire a captured image including the marker M1. Thereafter, the detection determining section 165 included in the marker detector 161A determines that the marker M1 is imaged in the captured image. The position managing section 167 included in the marker detector 161A generates, from captured image data acquired by the imaging controller 160, the latest position information 152 concerning the marker M1 disposed in the position K1. The position managing section 167 stores the generated latest position information 152 in the storage 15A. Thereafter, the position managing section 167 refers to the position information 152 stored in the storage 15A and determines that the latest position information 152 is information indicating the first position. The projector 1A achieves acquiring the identification information N1 from the marker M1 located in the first position and, after acquiring the identification information N1 from the marker M1 located in the first position, acquiring the identification information N1 from the marker M1 located in the second position different from the first position. The marker M1 after the projector 1A acquires the identification information N1 from the marker M1 located in the second position is located in the position K1, which is the first position. Therefore, the identification-information acquiring section 166 included in the marker detector 161A reads the QR code Q1 included in the marker M1 located in the position K1 to acquire the identification information N1 again. The process managing section 162 updates the latest process information N1 corresponding to the identification information N1. The latest process information 151 updated by the process managing section 162 is a character string “002” generated by referring to the character string “001” stored in the storage 15A. The process managing section 162 stores the latest process information 151 including the character string “002” in the storage 15A. The process managing section 162 generates the image identification information Nc2 from the identification information N1 and the latest process information 151. The image identification information Nc2 is the character string “053_002” as explained above. Thereafter, the display-image acquiring section 163 searches through the database DB provided in the image server 30 to acquire the projection image data D2 corresponding to the image identification information Nc2. The display controller 164 switches the image to be displayed from the projection image Img1 to the projection image Img2 based on the projection image data D2.

As explained above, the projector 1A according to the second embodiment acquires the identification information N1 from the marker M1 located in the position K1 and acquires the identification information N1 from the marker M1 located in the position K2 and, thereafter, acquires the identification information N1 from the marker M1 located in the position K1 again. Therefore, the projection image Img to be displayed by the projector 1A can be switched.

When the position managing section 167 determines whether the, latest position information 152 is the information indicating the first position, the position managing section 167 may determine whether a position indicated by the latest position information 152 is present within a range having a predetermined area. For example, when the first-time position information 152 is represented by a coordinate (X1, Y1) and the latest position information 152 is represented by a coordinate (Xn, Yn), the position managing setion 167 may determine whether Xn satisfies X1−α≤Xn≤X1+α and Yn satisfies Y1−β≤Yn≤Y1'0β. That is, the position managing section 167 may determine whether the coordinate (Xn, Yn) indicated by the latest position information 152 is present within a range having an area 4αβ centering on (X1, Y1). In this case, the range having the area 4αβ centering on (X1, Y1) is regarded as the first position. The value α satisfies α>0. The value β satisfies β>0.

The imaging region T may be divided into a plurality of small regions Tf and the marker M may move among the plurality of small regions Tf. Specifically, the projector 1A may acquire the identification information N from the marker N located within a range of one small region Tf among the plurality of small regions Tf, acquire the identification information N from the marker M located within a range of another small region Tf among the plurality of small regions Tf, and, thereafter, acquire the identification information N from the marker M located within the range of the one small region Tf again to switch an image to be displayed. In this case, the one small region Tf is regarded as the first position and the other small region Tf is regarded as the second position.

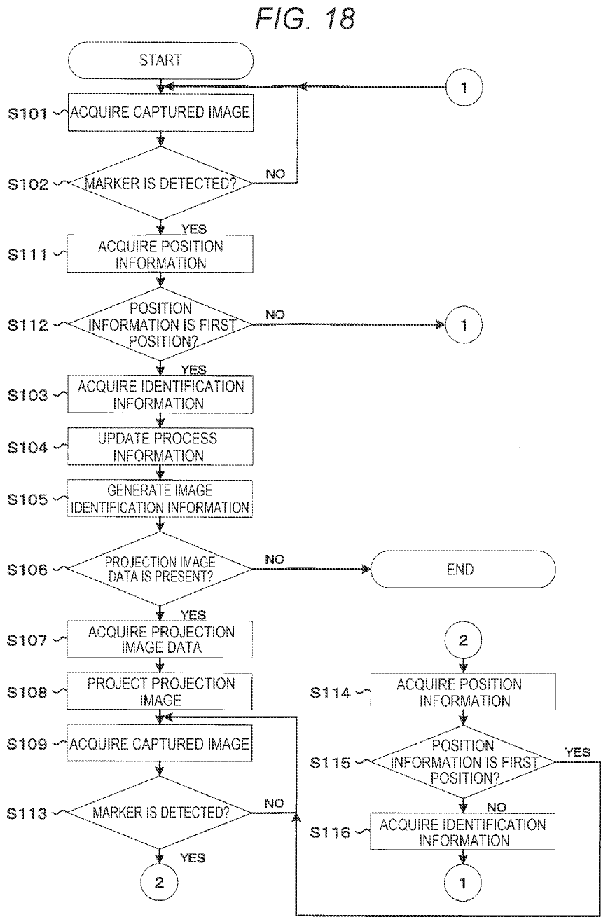

FIG. 18 is a flowchart for explaining the operation of the projector 1A according to the second embodiment. The flowchart of FIG. 18 is the same as the flowchart of FIG. 12 except that the controller 16A executes processing in steps S111 and S112 in addition to the processing in steps S101 to S109, executes processing in steps S113 to S116 instead of step S110, and, when a result of the determination in step S102 affirmative, the detection determining section 165 advances the processing to step S111 instead of advancing the processing to step S103.

In step S111, the position managing section 167 generates, from captured image data acquired by the imaging controller 160, the latest position information 152 concerning the imaged marker M1. The position managing section 167 stores the generated latest position information 152 the storage 15A.

In step S112, the position managing section 167 refers to the position information 152 stored in the storage 152 and determines whether the latest position information 152 is information indicating the first position. When determining in step S112 that the latest position information 152 is information indicating the first position, that is, when determining YES in step S112, the position managing section 167 advances the processing to step S103. When determining in step S112 that the latest position information 152 is not information indicating the first position, that is, when determining NO in step S112, the position managing section 167 advances the processing to step S101.

In step S113, the detection determining section 165 determines whether the marker Ml, specifically, the OR code Q1 included in the marker M1 is imaged in the captured image. When determining in step S113 that the QR code Q1 included in the marker M1 is imaged in the captured image, that is, when determining YES in step S113, the detection determining section 165 advances the processing to step S114. When determining in step S113 that the QR code Q1 included in the marker M1 is not imaged in the captured image, that is, when determining NO step S113, the detection determining section 165 advances the processing to step S109.

In step S114, the position managing section 167 generates, from captured image data acquired by the imaging controller 160, the latest position information 152 concerning the imaged marker M1. The position managing section 167 stores the generated latest. position information 152 in the storage 15A.

In step 3115, the position managing section 167 refers to the position information 152 stored in the storage 15A and determines whether the latest position information 152 is information indicating the first position. When determining in step S115 that the latest position information 152 is information indicating the first. position, that is, when determining YES in step S115, the position managing section 167 advances the processing to step S109. When determining in step S115 that the latest position information 152 is not information indicating the first position, that is, when determining NO in step S115, the position managing section 167 advances the processing to step S116.

In step S116, the identification-information acquiring section 166 reads the QR code Q1 to acquire the identification information N1.

The acquiring the identification information N1 from the QR code Q1 included in the marker M1 in step S103 after determining YES in step S112 means that the projector 1A acquires the identification information N1 from the marker M1 located in the first position. The acquiring the identification information N1 from the QR code Q1 included in the marker M1 in step S116 after determining NO in step S115 means that the projector 1A acquires the identification information N1 from the marker M1 located in the second position different from the first position. Every time the controller 16A executes the processing in steps S112 and S103 through the processing in steps S115 and S116, the projector 1A acquires the identification information N1 again. The latest process information 151 is updated every time the controller 16A executes the processing in step S104. The projection image Img projected from the projector 1A is switched every time the controller 16A executes the processing in step S108.

From above, according to the second embodiment, the projector 1A acquires the identification information N1 from the marker M1 located in the first position and acquires the identification information N1 from the marker M1 located in the second position and, thereafter, acquires the identification information N1 from the marker M1 located in the first position again. Therefore, the projection image Img to be displayed by the projector 1A can be switched. Accordingly, the operator can switch the projection image Img at any timing by operating the marker M1. The operator can set a moving distance of the marker M in switching the projection image Img shorter compared with the first embodiment.

As explained above, in the display method according to the second embodiment, the acquiring the identification information N1 includes the acquiring the identification information N1 from the marker M1 located in the position N1 and the acquiring the identification information N1 again includes the acquiring the identification information N1 from the marker M1 located in the position K2 different from the position K1 and, thereafter, acquiring the identification information N1 from the marker M1 located in the position K1.

That is, the operator can switch the projection image Img at any timing by controlling the position of the marker M1. Consequently, the operator can switch, according to the progress of the work, the projection image Img to be displayed.

In the second embodiment, the identification information N1 is an example of the “first information”, the marker M1 is an example of the “marker”, the position K1 is an example of the “first position”, and the position K2 is an example of the “second position”.

### 3. Third Embodiment

A third embodiment of the present disclosure is explained below. Components having the same action and functions as those in the first embodiment or the second embodiment are denoted by the reference numerals and signs used in the explanation of the first embodiment or the second embodiment and detailed explanation of the components is omitted as appropriate.

It is assumed that, like the projector 1 according to the first embodiment, a projector 113 according to the third embodiment acquires the identification information N1 from the marker M1 to project an image concerning cooking work for “sauteed saury”. It is assumed that the marker M1 is disposed within the range of the imaging region T on the cooking table 26 shown in FIG. 9. It is assumed that the marker M1 is not moved to the outside of the range of the imaging region T while an operator performs the cooking work.

In the third embodiment, re-acquisition conditions include a condition that the projector 1B acquires the identification information N1 from the marker M1 and a condition that a time period after the identification information N1 is acquired. That is, it is assumed that, after the predetermined time elapses after the identification information N1 is acquired, the projector 1B acquires the identification information N1 to switch an image to be displayed by the projector 1B.

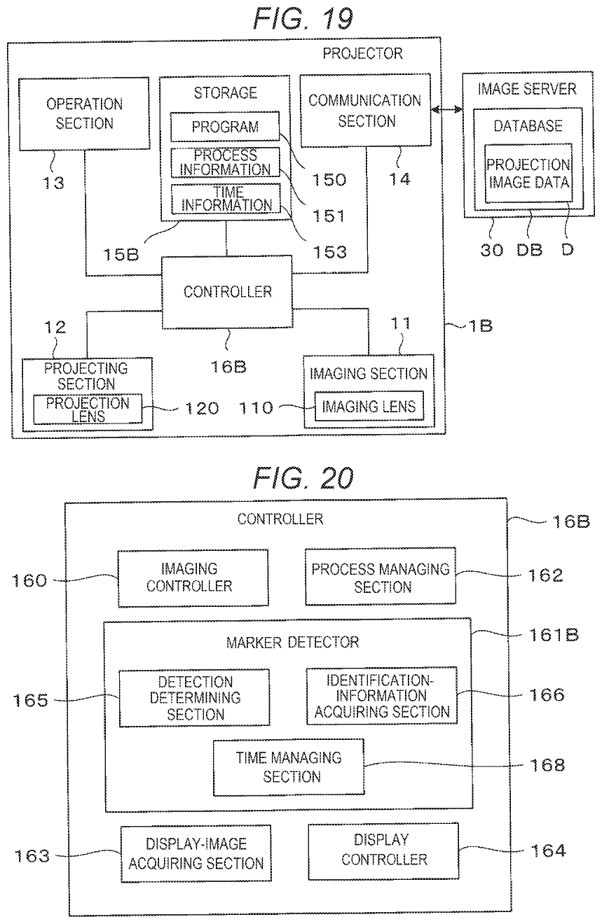

FIG. 19 is a block diagram showing the configuration of the projector 1B according to the third embodiment. The projector 1B is configured the same as the projector 1 according to the first embodiment except that the projector 1B,includes a storage 15B instead of the storage 15 and includes a controller 16B instead of the controller 16. The storage 15B is configured the same as the storage 15 except that the storage 15B stores time information 153 in addition to the program 150, the process information 151, and the like.

FIG. 20 is a block diagram showing a functional configuration of the controller 16B according to the third embodiment. The controller 16B is configured the same as the controller 16 according to the first embodiment except that the controller 16B has a function of a marker detector 161B instead of the marker detector 161. The marker detector 161B is configured the same as the marker detector 161 except that the marker detector 161B has a function of a time managing section 168 in addition to the detection determining section 165 and the identification-information acquiring section 166.

The time information 153 is information applied as a determination criterion in determining whether a predetermined time has elapsed from a certain point in time in the operation of the projector 1B. The time information 153 is specifically includes information concerning the certain point in time, that is, a start criterion of elapse of time, in other words, a base point and information concerning the predetermined time, that is, the length of time that needs to elapse. In this specification, the length of the time that needs to elapse is sometimes referred to as “necessary time length”. In the third embodiment, the base point of the elapse of time is set as “a point in time when the projector 1B acquires the identification information N1”. For example, when the time information 153 includes information concerning the length of time “three minutes” as the necessary time length, after three minutes more elapses after the projector 1B acquires the identification information N, the projector 1B acquires the identification information N. Therefore, an image to be displayed by the projector 1B can be switched.

The time information 153 may be changed as appropriate. For example, the operation section 13 receives input operation from the operator, whereby setting of the time information 153 may be changed.

The time managing section 168 refers to the time information 153 stored in the storage 15B and determines whether a predetermined time has elapsed from a certain point in time. In other words, the time managing section 168 refers to the time information 153 stored in the storage 15B and determines whether the length of time elapsed from a base point of the elapse of time is equal to or more than the necessary time length. For example, when the time information 153 includes information concerning the length of time “three minutes” as the necessary time length, the time managing section 168 sets the necessary time length of “three minutes” as a threshold and determines whether the length of the time elapsed from the base point is large or small.

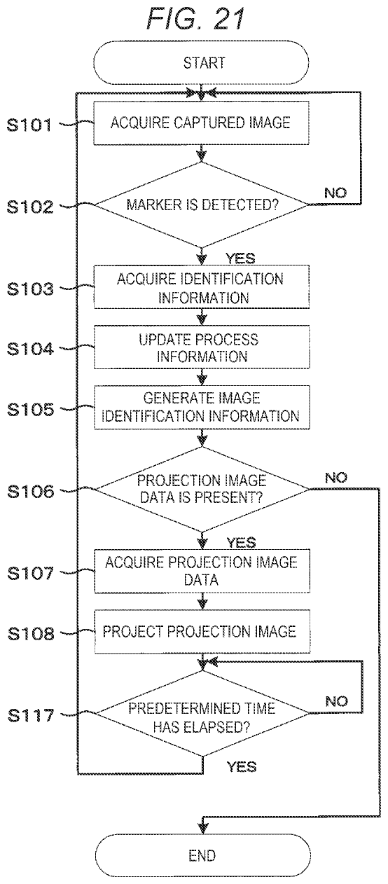

FIG. 21 is a flowchart for explaining the operation of the projector 1B according to the third embodiment. The flowchart of FIG. 21 is the same as the flowchart of FIG. 12 except that the controller 16B executes processing in step S117 instead of steps S109 and S110.

In step S117, the time managing section 168 refers to the time information 153 stored in the storage 15B and determines whether the length of time elapsed from a base point of elapse of time is equal to or more than the necessary time length. When determining in step S117 that the length of the time elapsed from the base point of the elapse of time is equal to or more than the necessary time length, that is, determining YES in step S117, the time managing section 168 advances the processing to step S101. When determining in step S117 that the length of the time elapsed from the base point of the elapse of time is not equal to or more than the necessary time length, that is, determining NO in step S117, the time managing section 168 executes the processing in step S117 again.

Specifically, in step S117, the time managing section 168 determines whether a predetermined time has elapsed after the identification-information acquiring section 166 included in the projector 1B acquires the identification information N1 from the marker M1 in step S103. When it is determined NO in step S117, that is, when the predetermined time has not elapsed after the identification-information acquiring section 166 acquires the identification information N1 from the marker M1 in step S103, the controller 16B repeats the determination in step S117 until the predetermined time elapses. When it is determined YES in step S117 because the predetermined time has elapsed from the base point of the elapse of time, the projector 13 executes the processing in step S103 to acquire the identification information N1 again. Thereafter, the controller 16B executes the processing in step S104, whereby the latest process information 151 updated. The controller 16B executes the processing in step S108, whereby the projection image Img projected from the projector 13 is switched.

From the above, according to the third embodiment, the projector 1B acquires the identification information N1 from the marker M1 and, after the predetermined time has elapsed after the identification information N1 is acquired, acquires the identification information N1 again. Therefore, the projection image Img to be displayed by the projector 1B can be switched. Accordingly, the operator can switch the projection image Img by waiting for the predetermined time to elapse without operating the marker M1. The operator can change the setting of the time information 153 as appropriate. Accordingly, the operator can optionally change, according to content of work corresponding to the identification information N, more specifically, a required time for carrying out procedures of the work, a time until the projection image Img is switched.

As explained above, in the display method according to the third embodiment, the acquiring the identification information N1 again includes the acquiring the identification information N1 after the predetermined time elapses after the identification information N1 is acquired.

That is, the operator can switch the projection image Img by waiting for the predetermined time to elapse without operating the marker M1. Consequently, even in a situation in which the operator cannot operate the marker M1, for example, when the operator cannot touch the marker M1 because a hand of the operator is dirty or when the operator performs work in a position apart from the projector 1B, the operator can continue work when the projection image Img is switched according to elapse of time.

In the third embodiment, the identification information N1 is an example of the “first information”.

### 4. Modifications

The embodiments explained above can be variously modified. Specific aspects of modifications are illustrated below. Two or more aspects optionally selected from the following illustration can be combined as appropriate within a range in which the aspects do not contradict one another. In the modifications illustrated below, components having the same action and functions as those in the embodiments are denoted by the reference numerals and signs used in the explanation of the embodiments and detailed explanation of the components is omitted as appropriate.

### 4.1. Modification 1

In the third embodiment, the case is illustrated in which the re-acquisition conditions include the condition that the projector 1B acquires the identification information N1 from the marker M1 and the condition that the predetermined time elapses after the identification information N1 is acquired. However, the present disclosure is not limited to such an aspect. The re-acquisition conditions may include a condition that the projector 1B acquires the identification information N1 from the marker M1 and a condition that a predetermined time elapses after the projector 1B displays an image concerning a certain procedure in the work corresponding to the identification information N1. That is, after the predetermined time elapses after the projector 1B displays the image concerning the certain procedure in the work corresponding to the identification information N1, the projector 1B may acquire the identification information N1 to switch an image to be displayed by the projector 1B.

A display method according to this modification is carried out in the projector 1B according to the third embodiment or a projector having the same configuration as the configuration of the projector 1B. In the following explanation, the display method according to this modification is explained illustrating the projector 1B.

As explained above, the storage 15B included in the projector 1B stores the time information 153. The time information 153 according to this modification is different from the time information 153 according to the third embodiment in that the base point of the elapse of time is a point set as “a point in time when the projector 1B displays an image concerning a1 certain procedure in the work corresponding to the identification information N1”. That is, when the projector 1B operates according to the flowchart of FIG. 21, in step S117, the time managing section 168 determines whether the predetermined time has elapsed after the projector 1B displays the projection image Img in step S108. When the time managing section 168 determines in step S117 that the predetermined time has elapsed after the projector 1B displays the projection image Img in step S108, the projector 1B executes the processing in step S103 to acquire the identification information N1 again. Thereafter, the controller 16B executes the processing in step S104, whereby the latest process information 151 is updated. The controller 16B executes the processing in step S108, whereby the projection image Img projected from the projector 1B is switched.

From the above, according to the modification 1, the projector 1B acquires the identification information N1 from the marker M1 and, after the predetermined time elapses after the image concerning the certain procedure in the work corresponding to the identification information N1 is displayed, acquires the identification information N1 again. Therefore, the projection image Img to be displayed by the projector 1B can be switched. Accordingly, the operator can switch the projection image Img by waiting for the predetermined time to elapse without operating the marker M1.

As explained above, in the display method according to the modification 1, the acquiring the identification information N1 again includes the acquiring the identification information N1 after the predetermined time elapses after the image concerning the certain procedure is displayed.

That is, the operator can switch the projection image Img by waiting for the predetermined time to elapse without operating the marker M1. Consequently, even in a situation in which the operator cannot operate the marker M1, for example, when the operator cannot touch the marker M1 because a hand of the operator is dirty or when the operator performs work in a position apart from the projector 1B, the operator can continue work when the projection image Imp is switched according to elapse of time.

In this modification, the identification information N1 is an example of the “first information” and the certain procedure (in the work corresponding to the identification information N1) is an example of the “first procedure”.

### 4.2. Modification 2

In the embodiments and the modification explained above, the case is illustrated in which the projector reads the QR code Q1 engraved on the marker M1 to acquire the identification information N1. However, the present disclosure is not limited by such as aspect. For example, a module that includes an infrared LED and flashes the LED at a predetermined interval to transmit the identification information N may be used as the marker M. In this modification, the marker M is capable of transmitting a plurality of kinds of identification information N by changing a flashing pattern of the LED. Accordingly, since the operator does not need to prepare a marker for each work, the operator can easily manage the marker. In this modification, since the marker M flashes the LED at the predetermined interval, the imaging section 11 is preferably capable of acquiring a moving image.

### 4.3. Modification 3

In the embodiments and the modifications explained above, the display method, the display system, and the program according to the present disclosure are explained illustrating the projector that projects an image. However, the present disclosure is not limited to such an aspect. For example, the display device may include, instead of the projector including the projecting section 12 that projects the projection image Img, a display panel that displays an image. Specifically, the projector includes a camera capable of acquiring the identification information N from the marker M. Alternatively, the projector may be an interactive whiteboard capable of communicating with the camera.

What is claimed is:

1. A display method comprising:
acquiring first information from a marker in which the first information is recorded;
displaying an image concerning a first procedure is work corresponding to the first information;
acquiring the first information from the marker again after the displaying the image concerning the first procedure; and
after the acquiring the first information again, displaying an image concerning a second procedure performed later than the first procedure in the work, the second procedure corresponding to the first information.

2. The display method according to claim 1, wherein the acquiring the first information again includes acquiring the first information after a time period after the first information is acquired.

3. The display method according to claim 1, wherein the acquiring the first information again includes acquiring the first information after a time period after the image concerning the first procedure is displayed.

4. The display method according to claim 1, wherein the acquiring the first information again includes acquiring the first information after a period that is started after the first information is acquired and in which the first information is not acquired.

5. The display method according to claim 1, wherein the acquiring the first information includes acquiring the first information from the marker located in a first position, and
the acquiring the first information again includes acquiring the first information from the marker located in a second position different from the first position and, thereafter, acquiring the first information from the marker located in the first position.

6. The display method according to claim 1, further comprising receiving a first input for instructing to acquire the first information again, wherein
the acquiring the first information again includes acquiring the first information when the first input is received.

7. The display method according to claim 1, further comprising:
receiving a second input for instructing to display the image concerning the first procedure after the displaying the image concerning the second procedure; and
displaying the image concerning the first procedure when the second input is received.

8. A display system comprising:
a sensor;
a display device; and
at least one processor programmed to execute:
acquiring, by controlling the sensor, first information from a marker in which the first information is recorded;
displaying, by controlling the display device, an image concerning a first procedure in work corresponding to the first information;
acquiring, by controlling the sensor, the first information from the marker again after the displaying the image concerning the first procedure; and
after the acquiring the first information again, displaying, by controlling the display device, an image concerning a second procedure performed later than the first procedure in the work, the second procedure corresponding to the first information.

9. A non-transitory computer-readable storage medium storing a program, the program instructing a processing device to:
acquire first information from a marker in which the first information is recorded;
display as image concerning a first procedure in work corresponding to the first information;
acquire the first information from the marker again after the displaying the image concerning the first procedure; and
after the acquiring the first information again, display an image concerning a second procedure performed later than the first procedure in the work, the second procedure corresponding to the first information.
